(19) United States
(12) Patent Application Publication
(10) Pub. No.: US 2003/0068410 A1
(43) Pub. Date: Apr. 10, 2003

(54) Food product and container combination

(76) Inventors: Paul A. Pezzoli, Coto de Caza, CA (US); Thomas W. Osip, Mission Viejo, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/971,415

(22) Filed: Oct. 5, 2001

(51) Int. Cl. C12C 1/027

(52) U.S. Cl. 426/106

(57) ABSTRACT

A product for retail sale includes a food product exhibiting the characteristic of syneresis in an improved container. The product minimizes the problems and inconvenience associated with dispensing such food products from conventional bottles. The container has a generally box-like shape with a spout located near the base of the container. The contents may be dispensed by squeezing without inverting the container. The product may be stacked for efficient storage, shipping, and display.

### FIELD OF THE INVENTION

The invention relates generally to a food product and container combination, and, more specifically, a liquid food product exhibiting the characteristic of syneresis in an improved dispensing container.

### BACKGROUND OF THE INVENTION

Bottles and containers for storing and dispensing liquid food products are presently available in a wide variety of shapes and sizes. Such a bottle generally has an elongated body and a spout located near its top end and rests upright on its base. To dispense the product, the bottle is inverted or tilted, and the product exits the spout.

Such bottles are generally acceptable when storing and dispensing a relatively fluid product such as water or oil. However, they are not well suited for use with viscous products, especially food products, exhibiting the characteristic of syneresis, i.e., the separation of water from a more viscous liquid. Specifically, upon standing, water or liquid separates from the product and sets at the top of the product. When the bottle is inverted for dispensing, the water, having greater fluidity, reaches and exits the spout of the bottle first. This results in an unwanted, unappetizing discharge of water from the bottle. The water either soaks into the food being eaten, creating a displeasing taste and unappetizing appearance, or splatters against a plate or other surface, creating stains or damage.

Consumers attempt to alleviate this problem by shaking the bottle before dispensing the product. Unfortunately, placing the burden on consumers is not an adequate solution to the problem. Consumers, hurried or distracted, regularly forget to shake the bottle and the problems described above continue to occur. Alternatively, the cap is often not closed or not securely affixed to the bottle. The bottle often opens during shaking and results in an undesired dispensing that the user must expend time and energy to clean. Such spillage often results in stains and damage to carpets, furniture, and fabrics. Additionally, the shaking of a bottle before use is a cumbersome, labor intensive activity. Persons with limited time and physical ability may not be able to perform this activity. Placing the burden on consumers to alleviate the problems associated with syneresis has failed to cure the problems associated with syneresis.

Others have built wells or chambers into the closure of the bottle to prevent the above-described problems. When the bottle is inverted for dispensing, the chambers are intended to trap the low-viscosity water before it can exit the bottle. However, these chambers do not prevent the discharge of water and associated problems.

Some manufacturers have created inverted bottles for dispensing viscous products such as liquid soap, shampoo, and gel products. However, these bottles are not suitable for use with food products exhibiting the characteristic of syneresis. These bottles either have a mechanism that permits the hanging of the bottle or an enlarged cap that serves as the base of the bottle. Hanging bottles have limited utility and are not suitable for food products that may not be hung when stored. Bottles that have caps functioning as the base of the bottles are unstable, limited to use with small, narrower bottles, and have increased costs due to the required larger caps.

Accordingly, a low-cost, efficient, bottle is needed to remedy the problems presently encountered when dispensing viscous liquid products exhibiting the characteristic of syneresis.

### SUMMARY OF THE INVENTION

The present invention is directed to a food product and container combination that satisfies the above needs. The invention in a preferred embodiment includes a container comprising a body formed of a generally flexible material having a top, a generally-horizontal base, a primary side wall adjacent the top, and an inclined panel between the generally-horizontal base and the top that forms an obtuse angle with the generally-horizontal base. The body defines an interior cavity that contains a predetermined amount of a food product exhibiting the characteristic of syneresis. An opening is provided in the inclined panel in fluid communication with the cavity. A cap is removably secured to the inclined panel to cover the opening, with the cap positioned so as not to hinder the generally-horizontal base from resting on a generally-horizontal surface.

The opening of the bottle is located proximate to the base such that the contents may be dispensed without inverting the bottle. As a result, water which has separated due to syneresis remains at the top of the container contents and does not exit the bottle when the food product is dispensed.

In another embodiment, the invention is directed to a food product and container combination where the container comprises a generally box-like body formed of a flexible material having a top, a base, a front, a back, two opposing sides, and an inclined panel connected to one of the sides and to the base. The top is generally parallel to the base, the front is generally parallel to the back, the two opposing sides are generally are generally parallel to each other, the front and the back are generally perpendicular to the two opposing sides, the top and the base are generally perpendicular to the front, the back, and the two opposing sides, and the inclined panel forms an obtuse angle with the base. The body defines an interior cavity that contains a predetermined amount of a food product exhibiting the characteristic of syneresis. A spout provides an opening to the cavity and extends from the inclined panel, but does not extend below the base and does not prevent the base from resting on a flat surface. A cap is removably secured to the inclined panel to cover to the spout.

Other features and advantages of the present invention will become apparent from the following detailed description of the preferred embodiment taken in conjunction with the accompanying drawings, which illustrate by way of example the principles of the invention.

### BRIEF DESCRIPTION OF THE DRAWINGS

FIG. 1 is a perspective view of a container with an attached cap embodying a part of the present invention.

FIG. 2 is a perspective view of the container of FIG. 1 depicting the spout and a detached cap.

FIG. 3 is a side view of the container depicted in FIG. 1.

FIG. 4 is an opposing side view of the container depicted in FIG. 1.

FIG. 5 is a top view of the container depicted in FIG. 1.

FIG. 6 is a front view of the container depicted in FIG. 1.

FIG. 7 is a bottom view of the container depicted in FIG. 1.

### DETAILED DESCRIPTION

The invention is directed to a food product that exhibits syneresis contained within an improved dispensing bottle. The bottle can be formed using extrusion blow molding, stretch blow molding, or any other suitable method of manufacture. The bottle may be made from a variety of plastic or polyester materials including, but not limited to, polyethylene, polypropylene, polyvinyl chloride (PVC), and polyethylene terephthalate (PET). The plastic is sufficiently rigid to maintain the shape of the bottle. The plastic maybe of any thickness desired, although the bottle is preferably sufficiently squeezable to expel the contents of the bottle upon squeezing. The plastic is preferably transparent so that the contents maybe viewed through the bottle. However, variations in color and properties of the plastic material will be known to those skilled in the art and are within the scope of the present invention.

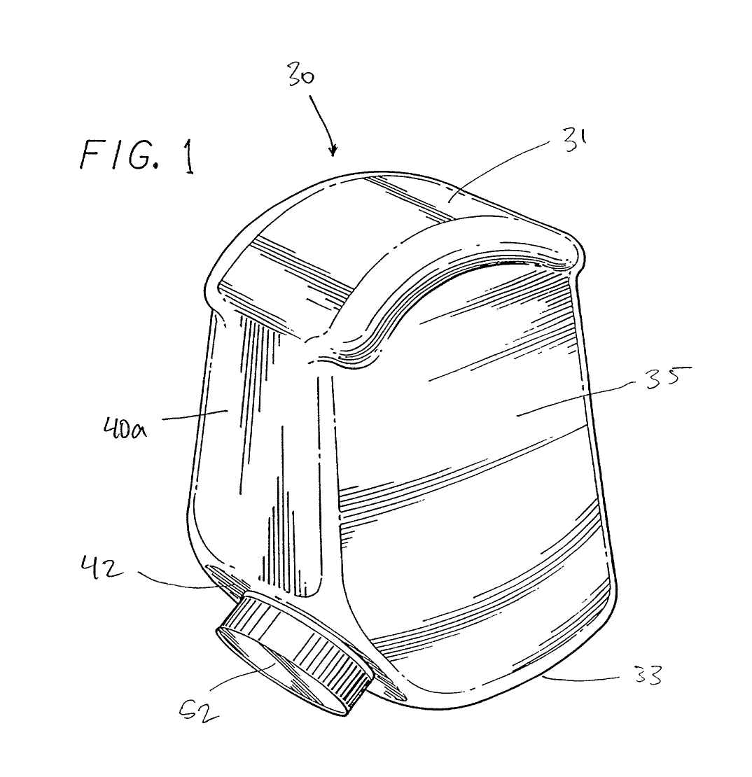

With reference to FIGS. 1 to 7, the bottle 30 includes a top 31, a generally-horizontal base 33, a front 35, a back 37, two opposing sides 40A and 40B, and an inclined panel 42, which are preferably seamlessly joined in a generally box-like configuration. The bottle preferably has smooth, rounded transitions between adjacent sides and panel. The bottle forms an interior cavity for containing a liquid food product within the bottle. A spout 45 extends from the inclined panel and forms an opening 47 to the cavity of the bottle, although any other suitable opening structure can be used.

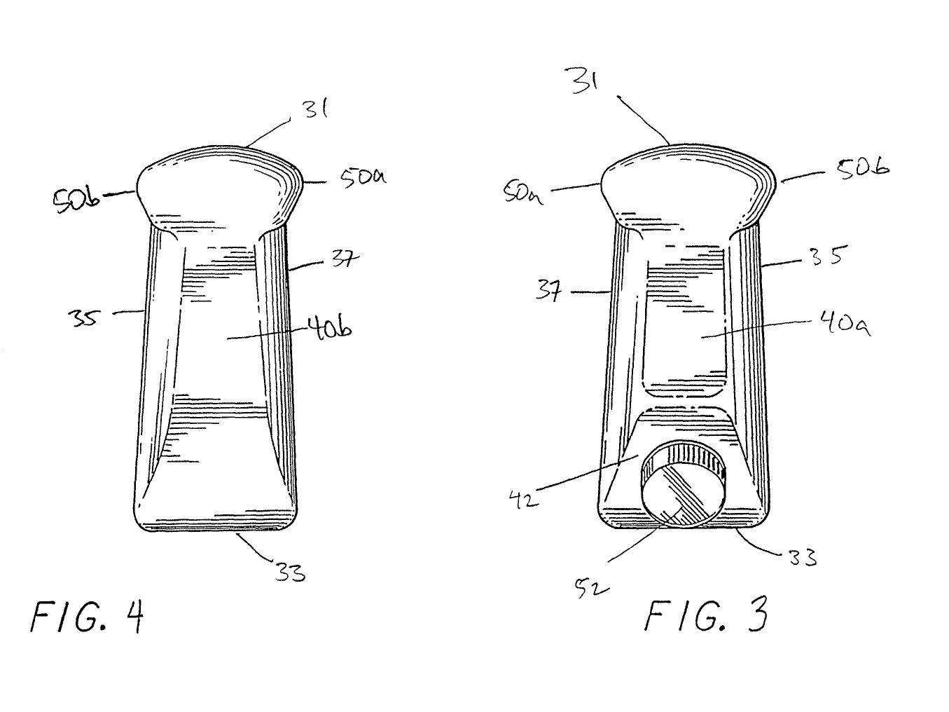

The top 31 is preferably convex, arched from one of the sides 40A to the opposing side 40B. Referring to FIGS. 3 to 5, the sides of the top 31 extend outwardly beyond the front 35 and the back 37 of the bottle 30, forming two arched ridges 50A and 50B across the top of the front 35 and the top of the back 37 of the bottle. The ridges 50A and 50B serve as a grip or handle for the user to hold and carry the bottle 30. Ridges may similarly be used to form a handle in connection with a flat or other shaped top.

The top 31 may alternatively be flat and substantially parallel to the base or may embody any other desired configuration. A flat top allows for stable stacking of multiple bottles, permitting efficient storage, shipping, or display in a retail store.

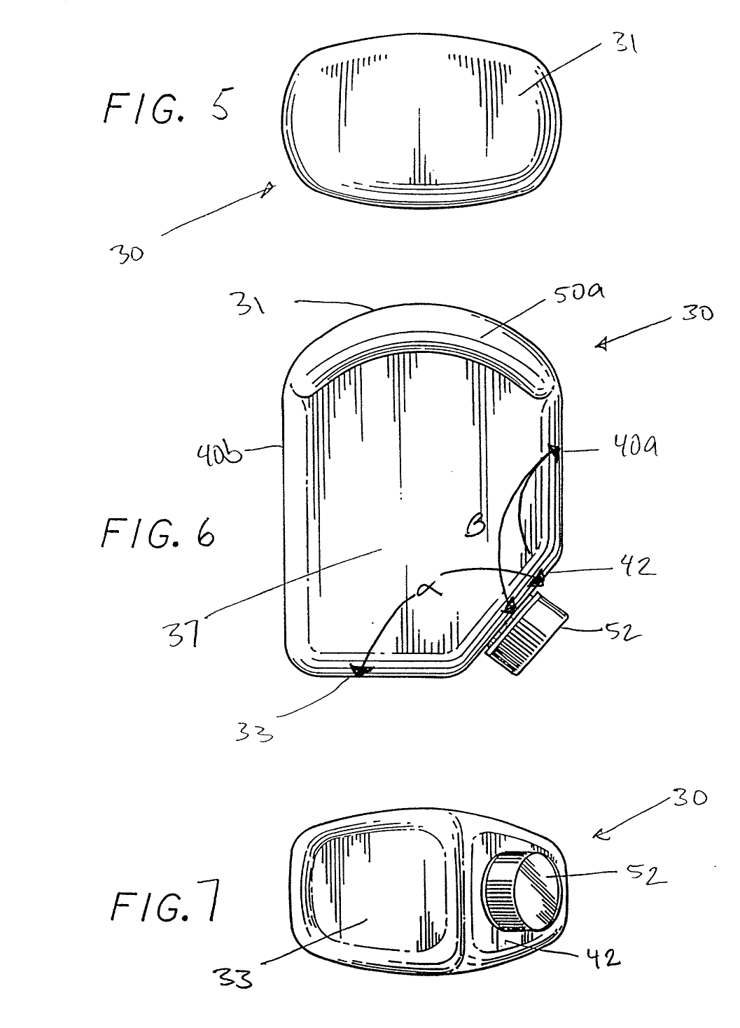

Referring to FIGS. 6 and 7, the generally-horizontal base 33 serves as a stable surface for the bottle to sit on a generally-horizontal surface, such as a table or shelf. In the depicted embodiment, the generally-horizontal base 33 is generally flat over its entire area. Alternatively the generally-horizontal base 33 can have a generally rectangular frame with a concave interior region that would be capable of receiving a convex top 31 of another similar bottle. Other suitable designs can be used for the generally-horizontaly base, as would be recognized by one skilled in the art. In the depicted embodiment, the length of the base 33 is less than the width of the bottle 30, the width of the bottle corresponding to the horizontal distance from one side 40A to the other side 40B. The length of the base 33 preferably ranges from about one-half to about two-thirds of the width of the bottle, but may be of any desired length.

In the depicted embodiment, the front 35 and the back 37 are each generally rectangular with a curved top edge and an angled lower corner where the inclined panel 42 joins the front and back, with the front 35 and back 37 substantially parallel to each other. Referring to FIGS. 3 and 4, the front 35 and back 37 are preferably angled slightly inward to create a tapering effect. The front 35 and back 37 have substantially smooth surfaces, allowing for the placement of product information, labels, and/or decals.

In the depicted embodiment, the two sides 40A and 40B are generally parallel to each other and generally perpendicular to the top 31, the base 33, the front 35, and the back 37. More particular, with reference to FIGS. 3 and 4, the sides 40A and 40B are preferably each generally rectangular with a slight taper toward the top 31 of the bottle. The sides 40A and 40B are preferably seamlessly connected to the top 31 and the base 33.

Referring to FIGS. 3, 6, and 7, the inclined panel 42 is generally rectangular and joins the base 33, directly or indirectly, to one of the two opposing sides 40a and the front 35 and the back 37 of the bottle 30. The inclined panel 42 is preferably slightly tapered toward the top 31. The inclined panel 42 forms an angle α with the generally-horizontal base 33 preferably ranging from about 110° to about 170°, more preferably ranging from about 125° to about 145°, still more preferably about 135°. Simultaneously, the inclined panel 42 forms an angle β with the side 40A to which it is joined preferably ranging about 110° to about 170° F., more preferably from about 125° to about 145°, still more preferably about 135°. The above angles describe the exemplary illustration in FIG. 5. If desired, the inclined panel 42 can be formed of a plurality of panels joined in a suitable configuration.

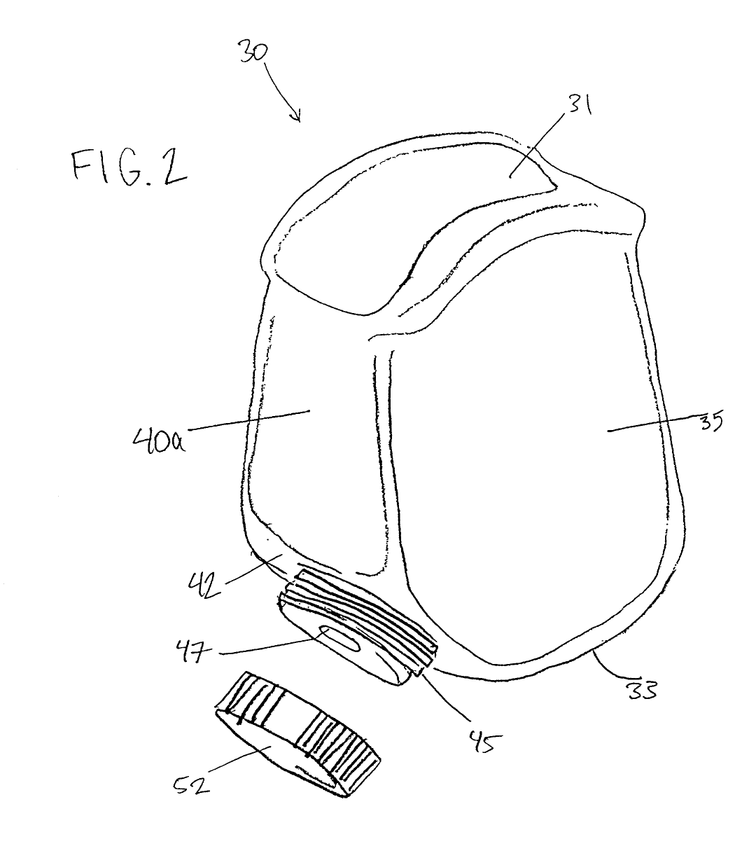

Referring primarily to FIG. 2, a spout 45 extends from the inclined panel 42. The spout 45 provides an opening 47 to the cavity of the bottle 30. The spout 45 is preferably threaded and configured for sealable connection with a conventional screw-on cap. The spout is preferably configured such that, with a cap 52 attached, the spout 45 does not interfere with the resting of the bottle 30 on its base 33. Accordingly, the spout 45 and cap 52 should not extend below the level of the base 33 such that the bottle 30 becomes unstable. In the depicted embodiments, the cap is screwed onto the spout to contain the food product within the bottle. Alternatively, the cap may comprise a flip top, a sport top, a twist top, or any other suitably configured cap that is removably attachable to the bottle.

The inventive bottle 30 is configured for use with a viscous liquid product exhibiting syneresis, such as ketchup, mustard, yogurt, custard, jelly, or gelatin. When the food product and container have been standing for a period of time, water rises to the top of the bottle, separating from the food product. Because the bottle opening is at the bottom of the bottle, water discharge from the bottle is greatly reduced when the food product is dispensed.

As would be recognized by one skilled in the art, the relative angles of the various panels of the container could be modified as desired, so long as the opening to the bottle is provided on a lower inclined panel near the base of the container. For example, the bottle could have a generally triangular top cross-section, with a front, back and only one side, where the inverted panel joins the one side to the base. In another alternative, the bottle has five side walls, forming a generally pentagon-shaped top cross-section. In yet another embodiment, the bottle has one flat side wall and a rounded side wall, such that the bottle has a generally circular or U-shaped top cross-section. Any other suitable side wall configuration can be provided that achieves the objects or functions of the invention. For example, one or more of the top, base, front, back, sides or invented panel may comprise a plurality of panels joined together in a suitable configuration. However, a generally-rectangular box-shaped is particularly suitable for efficient storage of the product in boxes and on grocery store shelves.

The preceding description has been presented with reference to presently preferred embodiments of the invention. Workers skilled in the art and technology to which this invention pertains will appreciate that alterations and changes in the described method may be practiced without meaningfully departing from the principal, spirit and scope of this invention. Accordingly, the foregoing description and accompanying drawings should not be read as pertaining only to the precise methods described, but rather should be read consistent with and as support to the following claims which are to have their fullest and fair scope.

We claim:

1. A food product and container combination comprising:
a predetermined amount of a food product exhibiting the characteristic of syneresis; and
a container comprising:
a body formed of a generally flexible material having a top, a generally-horizontal base, a primary side wall adjacent the top, and an inclined panel between the generally-horizontal base and the top that forms an obtuse angle with the generally-horizontal base, wherein the body defines an interior cavity in which the food product is contained;
an opening in the inclined panel in fluid communication with the cavity; and
a cap removably secured to the inclined panel to cover the opening, wherein the cap is positioned so as not to hinder the generally-horizontal base from resting on a generally-horizontal surface.

2. The food product and container combination of claim 1, wherein the body comprises a top generally parallel to the base, a front, a back generally parallel to the front and a second side wall generally parallel to the primary side wall.

3. The food product and container combination of claim 1, wherein the inclined panel is adjacent to the generally-horizontal base.

4. The food product and container combination of claim 1, wherein the inclined panel forms an angle with the generally-horizontal base ranging from about 110° to about 170°.

5. The food product and container combination of claim 1, wherein the inclined panel forms an angle with the generally-horizontal base ranging from about 125° to about 145°.

6. The food product and container combination of claim 1, wherein the container is formed by extrusion blow molding.

7. The food product and container combination of claim 6, wherein the container is formed from a material selected from the group consisting of polypropylene, polyvinyl chloride, polyethylene or polyethylene terephthalate.

8. The food product and container combination of claim 2, wherein the top extends outwardly beyond the side walls to form two ridges for gripping the container.

9. The food product and container combination of claim 1, wherein the top is convex.

10. The food product and container combination of claim 1, where in the generally-horizontal base includes a concave surface.

11. The food product and container combination of claim 1, wherein the food product is selected from the group consisting of ketchup, mustard, yogurt, custard, jelly and gelatin.

12. The food product and container according to claim 1, wherein the food product is selected from the group consisting of ketchup and mustard.

13. A food product and container combination comprising:
a predetermined amount of a food product exhibiting the characteristic of syneresis; and
a container comprising:
a generally box-like body formed of a flexible material having a top, a base, a front, a back, two opposing sides, and an inclined panel connected to one of the sides and to the base, whereby the top is generally parallel to the base, the front is generally parallel to the back, the two opposing sides are generally are generally parallel to each other, the front and the back are generally perpendicular to the two opposing sides, the top and the base are generally perpendicular to the front, the back, and the two opposing sides, and the inclined panel forms an obtuse angle with the base, and further wherein the body defines an interior cavity in which the food product is contained;
a spout providing an opening to the cavity extending from the inclined panel that does not extend below the base and does not prevent the base from resting on a flat surface; and
a cap removably secured to the inclined panel to cover to the spout.

14. The food product and container combination of claim 13, wherein the inclined panel forms an angle with the generally-horizontal base ranging from about 110° to about 170°.

15. The food product and container combination of claim 13, wherein the inclined panel forms an angle with the generally-horizontal base ranging from about 125° to about 145°.

16. The food product and container combination of claim 13, wherein the top extends outwardly beyond the side walls to form two ridges for gripping the container.

17. The food product and container combination of claim 13, wherein the top is convex.

18. The food product and container combination of claim 13, wherein the food product is selected from the group consisting of ketchup, mustard, yogurt, custard, jelly and gelatin.

19. The food product and container according to claim 13, wherein the food product is selected from the group consisting of ketchup and mustard.
